(19) United States
(12) Patent Application Publication
(10) Pub. No.: US 2023/0073555 A1
(43) Pub. Date: Mar. 9, 2023

(54) MANAGEMENT SYSTEM, DETECTION DEVICE, ESTIMATION DEVICE, AND PERFORATED PLATE

(71) Applicant: LIXIL Corporation, Tokyo (JP)

(72) Inventors: Kazuki TERABE, Tokyo (JP); Atsushi SHOJI, Tokyo (JP); Mitsuhiko TSUBOTA, Tokyo (JP); Sadaaki SHICHINO, Tokyo (JP)

(73) Assignee: LIXIL Corporation, Tokyo (JP)

(21) Appl. No.: 17/794,573

(22) PCT Filed: Aug. 25, 2020
(86) PCT No.: PCT/JP2020/031983

§ 371 Date: Jul. 21, 2022

(30) Foreign Application Priority Data
Jan. 24, 2020 (JP) 2020-009680

(51) Int. Cl. E03D 13/00; E03D 5/10; E03D 9/00; G01F 23/24; G01V 3/02

(52) U.S. Cl. CPC E03D 13/00; E03D 5/10; E03D 9/00; G01F 23/24; G01V 3/02

(57) ABSTRACT

A management system includes: a detection device including a main body that has a shape installable to a discharge port, electrodes that are provided in the main body and are detectors detecting a liquid, and a communication device that functions as a transmitter transmitting information regarding a detection result obtained by the detector; and an estimation device including a receiver that receives the information transmitted from the transmitter, and an estimator that estimates a discharge state of the liquid from the discharge port based on the information received by the receiver.

### CROSS-REFERENCE TO RELATED APPLICATIONS

This application is a national stage application under 35 U.S.C. 371 of International Application No. PCT/JP2020/031983, filed Aug. 25, 2020, which claims the priority of Japanese Application No. 2020-009680, filed Jan. 24, 2020, the entire contents of each priority application is incorporated herein by reference.

### FIELD OF THE DISCLOSURE

The present disclosure relates to a management system that manages a liquid discharge state in a toilet bowl or the like, a detection device, an estimation device, and a drain trap, which can be used in the management system.

### BACKGROUND OF THE DISCLOSURE

As a method of detecting clogging of a urinal, a technique of incorporating a sensor in the urinal has been proposed (refer to, for example, Patent Literature 1). Patent Literature 1 discloses a detection device including: a Doppler sensor that generates a Doppler signal by transmitting a propagation wave to a water sealing portion provided in a part of a drainage portion and receiving the propagation wave reflected by a water sealing surface of the water sealing portion; a water supply unit that supplies water toward the drainage portion; and a detector that acquires a time from when the water supply unit is controlled to supply water until amplitude of the Doppler signal is equal to or less than a first threshold value, and detects occurrence of clogging in the drainage portion when the acquired time exceeds a second threshold value.
Patent Literature 1: JP 2016-61030 A

### SUMMARY OF THE DISCLOSURE

In order to detect clogging of the urinal by applying the technique disclosed in Patent Literature 1, it is necessary to replace the existing urinal with the urinal disclosed in Patent Literature 1, and thus the introduction cost may be large. There is a demand for a technique of being capable of accurately detecting a discharge state of drainage water in the urinal or the like while suppressing the introduction cost.

The present disclosure has been made in view of such a problem, and an object thereof is to provide a technique of accurately detecting a liquid discharge state.

In order to solve the above problem, in some embodiments of the present disclosure, there is provided a management system including: a detection device including a main body having a shape installable to a discharge port, a detector provided in the main body and structured to detect a liquid, and a transmitter structured to transmit information regarding a detection result obtained by the detector; and an estimation device including a receiver structured to receive the information transmitted from the transmitter, and an estimator structured to estimate a discharge state of the liquid from the discharge port based on the information received by the receiver.

In some embodiments of the present disclosure, there is provided a detection device. This detection device includes: a main body having a shape installable to a discharge port; a detector provided in the main body and structured to detect a liquid; and a transmitter structured to transmit information regarding a detection result obtained by the detector.

In some embodiments of the present disclosure, there is provided an estimation device. This estimation device includes: a receiver installed to a discharge port and structured to receive information transmitted from a detection device structured to detect a liquid; and an estimator structured to estimate a discharge state of the liquid from the discharge port based on the information received by the receiver.

In some embodiments of the present disclosure, there is provided a drain trap. This drain trap is to be installed in a discharge port, the drain trap including: a main body having a shape installable to the discharge port; a detector provided in the main body and structured to detect a liquid; and a transmitter structured to transmit information regarding a detection result obtained by the detector.

Note that an arbitrary combination of the above constituent elements and expressions of the present disclosure made by using a device, a system, a recording medium, a computer program, and the like are also effective as the aspects of the present disclosure.

### BRIEF DESCRIPTION OF THE FIGURES

FIG. 1 is a front view of a urinal according to some embodiments;

FIG. 2 is a plan view of a urinal according to some embodiments;

FIG. 3 is a view illustrating a configuration of a urinal according to some embodiments;

FIG. 4 is a view illustrating an outer appearance of a drain trap according to some embodiments;

FIG. 5 is a view schematically illustrating a configuration of a drain trap according to some embodiments;

FIG. 6 is a view illustrating a state when drainage water is accumulated in a bowl.

FIG. 7 is a diagram illustrating a configuration of an estimation device according to some embodiments;

FIG. 8 is a diagram illustrating a configuration of an estimation device according to some embodiments; and

FIGS. 9A-9B are views illustrating another drain trap according to some embodiments.

### DETAILED DESCRIPTION OF THE DISCLOSURE

In some embodiments of the present disclosure, a technique of incorporating, in a drain trap installed to a discharge port of a urinal, a detection device including a detector for detecting drainage water and a transmitter that transmits information regarding a detection result obtained by the detector to the outside will be described. In some embodiments, a technique of estimating a discharge state of drainage water based on the detection result obtained by the detection device will be described. In some embodiments, a technique of estimating a use situation of a urinal based on the detection result obtained by the detection device and managing cleaning of the urinal will be described.

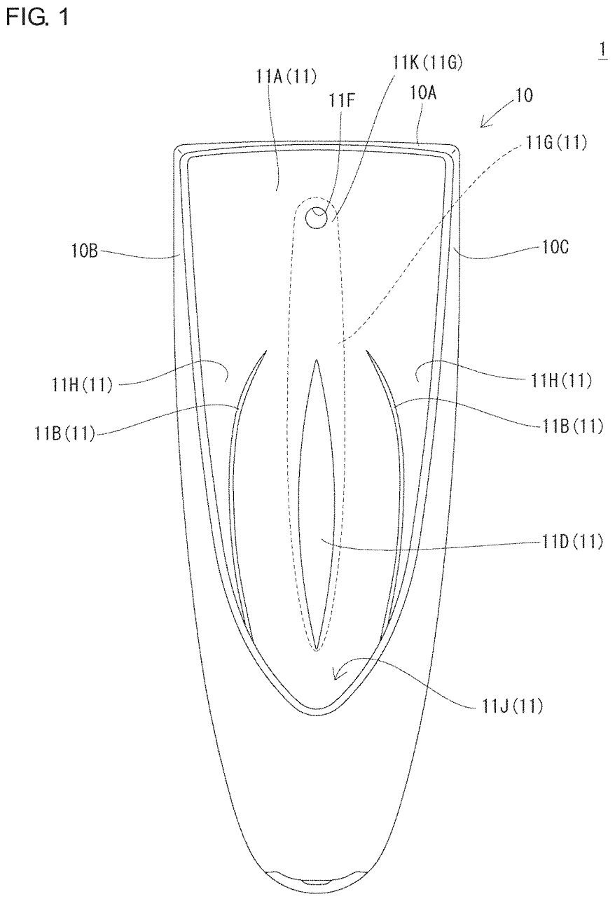

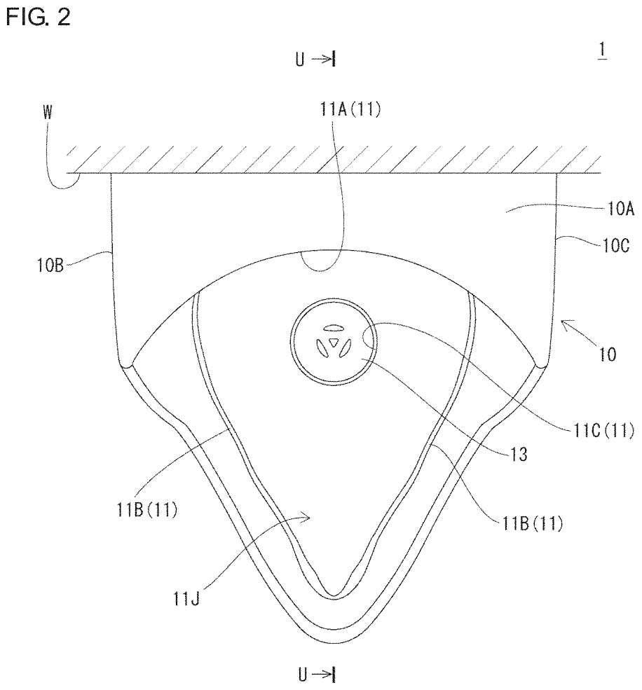

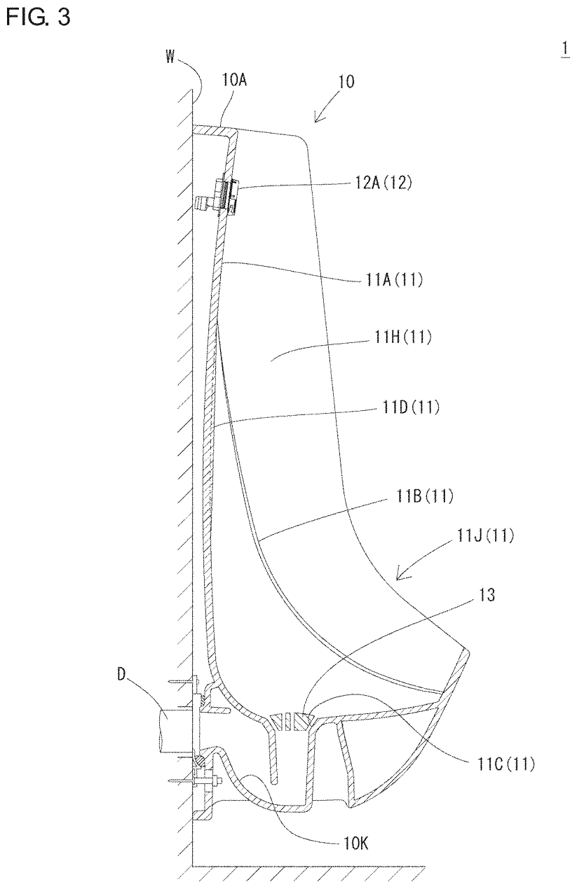

FIGS. 1 to 3 are views illustrating a configuration of a urinal according to some embodiments. FIG. 1 is a front view of a urinal 1. FIG. 2 is a plan view of the urinal 1. FIG. 3 is a cross-sectional view taken along arrow line U-U in FIG. 2. The urinal 1 includes a urinal body 10, a bowl 11, a water discharge unit 12, and a drain trap 13.

The urinal body 10 has an upper end surface 10A, a left side surface 10B, and a right side surface 10C. The upper end surface 10A has a flat plate shape, has a width in a depth direction (the depth direction indicates a near side and a far side in FIG. 1, and hereinafter, the same applies to this), and extends in a transverse direction (the transverse direction indicates a right side and a left side in FIG. 1, and hereinafter, the same applies to this). The central portion in the transverse direction of a front end of the upper end surface 10A is recessed and curved in a rear direction.

The left side surface 10B has a width in the depth direction and extends downward (The downward indicates the lower side in FIG. 1, and hereinafter, the same applies to this) from the left end of the upper end surface 10A. Furthermore, the right side surface 10C has a width in the depth direction and extends downward from the right end of the upper end surface 10A. A dimension between the left side surface 10B and the right side surface 10C decreases as being directed toward the lower side. Furthermore, the front side of the lower end portion of the left side surface 10B and the front side of the lower end portion of the right side surface 10C protrude in the front direction to extend toward the central portion in the transverse direction, and are connected to each other at the central portion in the transverse direction. Furthermore, the central portion in the transverse direction where the left side surface 10B and the right side surface 10C are connected to each other retreats as being directed toward the lower end. In the urinal body 10, rear ends of the upper end surface 10A, left side surface 10B, and right side surface 10C are formed on the same plane. Thus, the urinal body 10 can be attached to a wall surface W for installation by bringing the rear ends of the upper end surface 10A, left side surface 10B, right side surface 10C, which are formed on the same plane, into contact with the wall surface W (refer to FIGS. 2 and 3).

The bowl 11 has an opposing surface 11A, a pair of right and left washing steps 11B, a discharge port 11C, and a protrusion 11D. The opposing surface 11A is recessed and curved in the rear direction at the central portion in the transverse direction, faces forward, and extends in a longitudinal direction. Specifically, a right-left intermediate portion 11G is formed from the upper portion to the lower portion of the central portion in the transverse direction of the opposing surface 11A, the right-left intermediate portion 11G having a width in the transverse direction and extending in the longitudinal direction. The right-left intermediate portion 11G is formed in a substantially planar shape, and the central portion in the transverse direction of the right-left intermediate portion 11G is slightly recessed and curved, and faces forward. Furthermore, the opposing surface 11A is provided with a planar portion 11K formed in a planar shape at the upper end portion of the right-left intermediate portion 11G. Furthermore, a pair of curved surfaces 11H curved forward from both right and left sides of the right-left intermediate portion 11G are formed on the opposing surface 11A. These curved surfaces 11H are symmetric to each other at the central portion in the transverse direction. These curved surfaces 11H are continuous with each other at the upper end of the right-left intermediate portion 11G and extend to the upper end of the opposing surface 11A. Furthermore, these curved surfaces 11H are continuous with each other at the lower end of the right-left intermediate portion 11G and extend to the lower end of the opposing surface 11A. In the horizontal sectional shape of the opposing surface 11A in the use state, the curvature radius of the portion formed by the curved surfaces 11H gradually decreases as being directed to the lower side. Furthermore, a bowl-shaped portion 11J expanding downward in a bowl shape is formed at the lower end portion of the bowl 11. In the bowl 11, a rear side of the bowl-shaped portion 11J is the lower end portion of the opposing surface 11A. In the bowl 11, the upper end of the opposing surface 11A is connected to the front end of the upper end surface 10A of the urinal body 10. Furthermore, in the bowl 11, both right and left ends of the opposing surface 11A and the front upper end of the bowl-shaped portion 11J are connected to the front ends of the left side surface 10B and the right side surface 10C of the urinal body 10, respectively. Furthermore, on the opposing surface 11A, an insertion hole 11F provided to penetrate the planar portion 11K formed on the upper end portion of the right-left intermediate portion 11G in the depth direction is provided.

The pair of right and left washing steps 11B are provided on both right and left sides of the bowl 11 so as to extend in the longitudinal direction. Specifically, the pair of right and left washing steps 11B are respectively provided on the pair of curved surfaces 11H symmetrically to the center in the transverse direction. Furthermore, the upper end of each of the pair of right and left washing steps 11B is located near the right and left sides of the right-left intermediate portion 11G. Furthermore, the upper ends of the pair of right and left washing steps 11B are provided on the lower side from the insertion hole 11F at a predetermined interval with the insertion hole 11F provided on the planar portion 11K formed on the upper end portion of the right-left intermediate portion 11G of the opposing surface 11A. Furthermore, the pair of right and left washing steps 11B extend to be inclined with respect to the curved surfaces 11H of the opposing surface 11A downward and forward. Specifically, the pair of right and left washing steps 11B are recessed and curved downward and extends obliquely downward and forward (refer to FIG. 3). Furthermore, a dimension between the pair of right and left washing steps 11B in the transverse direction increases as being directed from the upper end to the central portion in the longitudinal direction (refer to FIG. 1). Furthermore, the dimension between the pair of right and left washing steps 11B in the transverse direction decreases as being directed from the central portion in the longitudinal direction to the lower end (refer to FIG. 1). Furthermore, the lower ends of the pair of right and left washing steps 11B are connected to each other at the central portion in the transverse direction on the front side of the bowl-shaped portion 11J of the bowl 11 (refer to FIG. 2).

The discharge port 11C is provided at the lower end of the bowl-shaped portion 11J of the bowl 11 so as to be open in the longitudinal direction. That is, the discharge port 11C is formed at the lower end of the bowl 11. The discharge port 11C is located on the rear side of the lower ends of the pair of right and left washing steps 11B. The discharge port 11C is connected to a drain pipe D drawn out from the wall surface W installed via a discharge passage 10K provided on the downstream side of the discharge port 11C (refer to FIG. 3).

In the use state, the protrusion 11D is formed to protrude forward from the central portion in the transverse direction of the opposing surface 11A and extend in the longitudinal direction. The upper end of the protrusion 11D is located below the upper ends of the pair of right and left washing steps 11B and extends downward. Specifically, the upper end of the protrusion 11D is located below the upper ends of the pair of right and left washing steps 11B and near the upper ends of the pair of right and left washing steps 11B (refer to FIG. 1). Furthermore, the lower end of the protrusion 11D extends to the lower end portion that is the lower portion of the opposing surface 11A. The protrusion 11D is formed so as to gradually protrude forward as being directed to the central portion in the transverse direction of the opposing surface 11A. Furthermore, a dimension of the protrusion 11D in the transverse direction at the central portion in the longitudinal direction is greater than the dimensions of the upper end portion and the lower end portion in the transverse direction (refer to FIG. 1). Furthermore, the dimension of the protrusion 11D protruding forward at the central portion in the longitudinal direction is greater than the dimensions of the upper end portion and lower end portion protruding forward.

The water discharge unit 12 includes a spreader 12A, which is a water discharge tool. The spreader 12A has a disk-like shape, and a center axis of the disk-like shape extends in the depth direction. A disk-like rear end surface of the spreader 12A is formed in a planar shape. The spreader 12A comes into contact with the planar portion 11K formed at the upper end portion of the right-left intermediate portion 11G of the opposing surface 11A, and covers the insertion hole 11F formed at the upper end portion of the opposing surface 11A from the front side to be attached. In this manner, the spreader 12A is provided above the protrusion 11D and the pair of right and left washing steps 11B. Furthermore, the spreader 12A is attached to the planar portion 11K formed at the upper end portion of the right-left intermediate portion 11G of the opposing surface 11A. Furthermore, the spreader 12A is provided with a human body detection sensor on a disk-like front end surface.

The drain trap 13 has a disk-like shape, and a center axis of the disk-like shape extends in the longitudinal direction. The outer diameter of the drain trap 13 is slightly greater than the inner diameter of the discharge port 11C. A plurality of protrusions (not illustrated) are provided on a disk-like outer circumferential surface of the drain trap 13 toward the outer side in a radial direction. A plurality of the protrusions have the same dimension protruding from the outer circumferential surface. The drain trap 13 is placed on the discharge port 11C. At this time, a plurality of the protrusions of the drain trap 13 comes into contact with an inner circumferential surface of the discharge port 11C. Thus, the disk-like outer circumferential surface of the drain trap 13 does not come into contact with the inner circumferential surface of the discharge port 11C, and a predetermined space can be provided between the disk-like outer circumferential surface and the inner circumferential surface of the discharge port 11C. At this time, the lower end of the protrusion 11D provided on the opposing surface 11A of the bowl 11 is spaced apart from an outer circumferential edge of the drain trap 13.

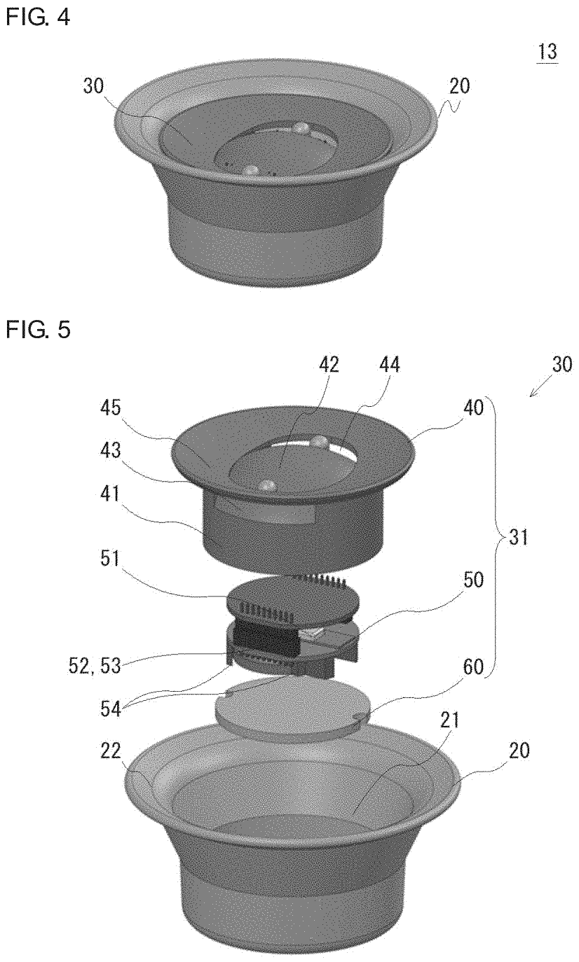

FIG. 4 is a view illustrating an outer appearance of the drain trap according to some embodiments. The drain trap 13 includes a drain trap body 20 and a detection device 30 placed so as to be fitted inside the drain trap body 20. The detection device 30 detects a liquid present in the bowl 11 above the discharge port 11C, and transmits information regarding the detected result to an external estimation device. The transmitted information may be the detected result itself or may be information generated based on the detected result. The estimation device estimates a discharge state in the discharge port 11C or the discharge path (the discharge passage 10K, the drain pipe D, and the like) based on the information received from the detection device 30.

The detection device 30 may be configured integrally with the drain trap body 20, or may be configured separately from the drain trap body 20. In the former case, the technique of some embodiments can be applied only by replacing the drain trap of the existing urinal with the drain trap 13 of some embodiments without replacing or repairing the urinal itself, and thus the introduction cost can be reduced. In the latter case, the detection device 30 may have a shape that can be fitted into or placed on the existing drain trap body 20. Thus, the technique of some embodiments can be applied only by fitting the detection device 30 of some embodiments into or placing the detection device 30 on the drain trap of the existing urinal without replacing or repairing the urinal itself, and thus the introduction cost can be reduced.

FIG. 5 is a view schematically illustrating a configuration of the drain trap according to some embodiments. The drain trap body 20 has a bowl-like shape having a recess 21 inside, and the detection device 30 has an external shape fitted in the recess 21 of the drain trap body 20. The detection device 30 includes a main body 31, a substrate 51 on which a communication device functioning as a transmitter is mounted, and a pair of electrodes 54 functioning as a detector.

The main body 31 includes a cover 40, a housing portion 50, and a bottom surface 60. The housing portion 50 houses the substrate 51, the electrodes 54, and a battery (not illustrated) that supplies power to the substrate 51. The substrate 51 includes a processing device 52 and a communication device 53. The processing device 52 includes an ammeter that measures a current flowing between the pair of electrodes 54. The processing device 52 generates communication data to be transmitted to the estimation device based on the measurement result obtained by the ammeter. For example, the processing device 52 may directly use a current value or a resistance value, which is measured by the ammeter, as the communication data, or may count, as the communication data, the time when the current value measured by the ammeter is continuously equal to or greater than a predetermined value. The communication device 53 transmits the communication data generated by the processing device 52 to the estimation device in a wireless communication manner.

The electrodes 54 are provided so as to protrude to the outside of the housing portion 50. When the drainage water exists between the electrodes 54, the electrodes 54 are electrically connected by the drainage water, and thus the current is detected by the ammeter. While the urinal 1 is in use, or while washing water is discharged after the urinal 1 is used or when the urinal 1 is not used, the drainage water flows inside the drain trap 13, and thus the current is detected by the ammeter. In a case where the states of the discharge port 11C and the discharge path are normal, the liquid level of the drainage water becomes lower than the electrodes 54 when a certain period of time elapses. Therefore, the electrodes 54 are not electrically connected to each other, and the current is not detected by the ammeter. However, when the drainage water is not normally discharged due to clogging of the discharge port 11C or the discharge path, the time at which the drainage water is accumulated inside the drain trap 13 becomes long, and thus the time at which the current is detected by the ammeter becomes long. Therefore, in some embodiments, the discharge state of the drainage water from the discharge port 11C, such as whether or not the discharge port 11C or the discharge path is clogged, the degree of clogging, the amount of drainage water remaining in the bowl 11, and overflow of the drainage water from the bowl 11, is estimated based on the time when the current is continuously detected. Thus, the discharge state can be accurately estimated with a simple configuration. Therefore, the introduction cost can be reduced.

Since urine contains more ions than clean water used as washing water, when the urine is flowing between the electrodes 54, a resistance value measured by the ammeter is smaller than that when only the washing water is flowing. Therefore, by analyzing the current value or resistance value measured by the ammeter, the number of times, amount, time of the urination, and a component of the urine can be estimated. Even in a state in which the drainage water is normally discharged, the current is continuously detected by the ammeter during the period in which the urination is performed and the period in which the washing water is discharged. However, since the time and amount of urination vary depending on the person, the period in which the current is continuously detected by the ammeter also varies depending on the person. Accordingly, the period in which the urination is being performed may be identified based on the current value or resistance value measured by the ammeter. Thus, the influence of individual differences in the urination time can be reduced. Therefore, the discharge state of the drainage water can be estimated more accurately. In a case where not only simple clean water but also water containing detergent or the like is used as the washing water, the current value or resistance value of the washing water only need to be measured in advance.

The cover 40 includes a cylindrical portion 41, an upper surface 42, and a water collection portion 45. The housing portion 50 is housed in a watertight space formed by the cylindrical portion 41, the upper surface 42, and the bottom surface 60. An opening 43 is provided between the upper surface 42 and the water collection portion 45 above the positions of the electrodes 54 in the cylindrical portion 41. The upper surface 42 is inclined to be lower toward the opening 43. An opening 44 is also provided between the upper surface 42 and the water collection portion 45 on a side opposite to the opening 43. The water collection portion 45 is formed in a doughnut shape so as to be smoothly connected to an edge portion 22 of the drain trap body 20. The upper surface of the water collection portion 45 is inclined such that the upper side of the opening 43 is lowered. The drainage water flows from the edge portion 22 of the drain trap body 20 to the water collection portion 45, and falls from a central opening of the water collection portion 45 to the upper surface 42. When a large amount of drainage water remains, the drainage water is discharged from both the opening 43 and the opening 44, but when the amount of drainage water decreases, the remaining drainage water flows toward the lower opening 43 due to the inclination of the upper surface 42 and is discharged from the opening 43 to a portion between the electrodes 54. Thus, it is possible to more reliably detect that the drainage water remains in the bowl 11.

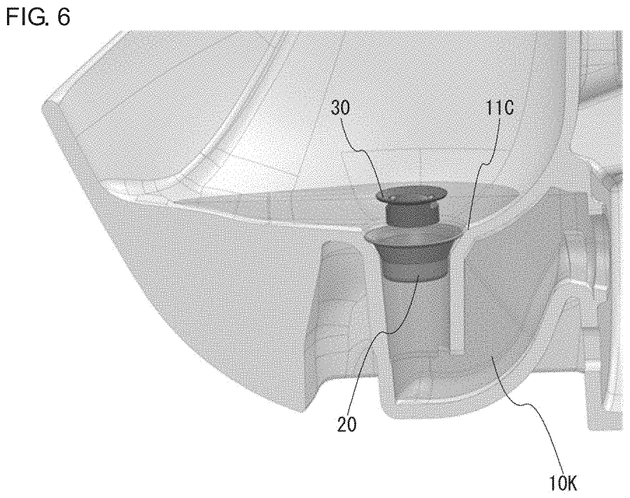

FIG. 6 is a view illustrating a state when drainage water is accumulated in the bowl. When the communication device 53 is submerged in the drainage water, there is a possibility that a radio wave transmitted from the communication device 53 is attenuated to interfere with communication. Thus, at least the communication device 53 is configured to float on the water. In some embodiments, since the substrate 51 on which the communication device 53 is mounted is housed in the housing portion 50 and the housing portion 50 is housed in the main body 31, the entire detection device 30 is configured to float on the water. In another example, only the communication device 53 or only the communication device 53 and only some configurations may float on the water, and the other configurations may sink together with the drain trap body 20. With such a configuration, the communication intensity of the communication device 53 can be secured, and the stability of wireless communication can be improved. Furthermore, the power required for communication can be reduced, and thus the battery can last longer.

A floating height detector for detecting a floating height when the configuration including the communication device 53 floats on the drainage water due to the drainage water accumulated in the bowl 11 may be further provided. The floating height detector may include, for example, a resistance line extending in a vertical direction and an ammeter that measures a resistance value of the resistance line. In this case, the lower end of the resistance line is attached to the drain trap body 20 or a configuration that maintains a state of being sunk together with the drain trap body 20 without floating on the water, and the configuration that floats on the drainage water is provided with an electrical contact configured such that a conductive position with the resistance line changes according to a floating height. A floating position detector may be an ultrasonic sensor, a distance measurement sensor, or the like for detecting the height between the floating configuration and the drain trap body 20. Since the water level of the drainage water accumulated in the bowl 11 can be estimated based on the floating height detected by the floating height detector, the discharge state of the drainage water can be estimated more accurately. Furthermore, it is possible to detect overflow of the drainage water from the bowl 11 or issue a warning before the drainage water overflows from the bowl 11.

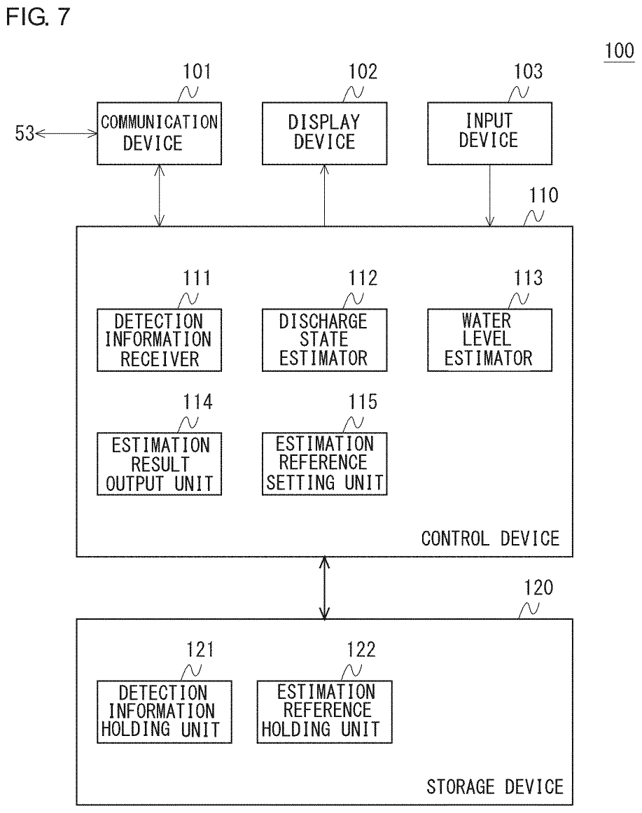

FIG. 7 is a diagram illustrating a configuration of an estimation device 100 according to some embodiments. The estimation device 100 includes a communication device 101, a display device 102, an input device 103, a storage device 120, and a control device 110. The estimation device 100 may be a server device, a device such as a personal computer, or a mobile terminal such as a mobile phone terminal, a smartphone, or a tablet terminal.

The communication device 101 controls communication with other devices. The communication device 101 receives information from the communication device 53 of the detection device 30 in a wireless communication manner. The communication device 101 may communicate with other devices in any of wired communication scheme or wireless communication scheme.

The display device 102 displays a screen generated by the control device 110. The display device 102 may be a liquid crystal display device, an organic EL display device, or the like. The input device 103 transmits an instruction input performed by the user of the estimation device 100 to the control device 110. The input device 103 may be a mouse, a keyboard, a touch pad, or the like. The display device 102 and the input device 103 may be mounted as a touch panel.

The storage device 120 stores a program, data, and the like used by the control device 110. The storage device 120 may be a semiconductor memory, a hard disk, or the like. The storage device 120 includes a detection information holding unit 121 and an estimation reference holding unit 122.

The detection information holding unit 121 holds information received from the detection device 30. The estimation reference holding unit 122 holds an estimation reference for estimating a discharge state of the drainage water from the discharge port 11C of the urinal 1.

The estimation reference may be a reference related to a time at which the presence of the drainage water is continuously detected by the detection device 30. For example, in a case where the time at which the presence of the drainage water is continuously detected exceeds a predetermined threshold value, it may be estimated that the discharge port 11C or the discharge path is clogged. Furthermore, the degree of clogging of the discharge port 11C or the discharge path may be estimated in accordance with the time at which the presence of the drainage water is continuously detected.

In a case where the current value or the resistance value is measured by the ammeter, the estimation reference may be a reference related to the measured current value or resistance value. For example, whether or not the urination is being performed may be identified based on the measured current value or resistance value, a time until the discharged washing water is discharged after the urination may be calculated by subtracting a period during which the urination is being performed from the time at which the presence of the drainage water is continuously detected, and the discharge state of the drainage water may be estimated based on the calculated time. The estimation reference may be a reference relating to statistical values such as an average value, a maximum value, a minimum value, a median value, a change rate, an average value of the change rate, and a change rate of the change rate, which are calculated from a time-series current value or resistance value. The estimation reference may be a reference related to a shape of a waveform indicating a temporal change of the current value or resistance value.

The estimation reference may be an algorithm that receives detection information received from the detection device 30 or generation information generated based on the detection information, and outputs a discharge state of drainage water from the discharge port 11C of the urinal 1. This algorithm is realized by a neural network or the like, and may be trained by machine learning. In the machine learning, a set of past detection information or past generation information and information indicating the discharge state of drainage water at that time may be used as training data. In this case, when the past detection information or the past generation information is input to an input layer of the neural network, an intermediate layer of the neural network may be adjusted such that information indicating the discharge state of the drainage water at that time is output from an output layer of the neural network.

In a case where there is a correlation between the detection information or generation information and the water level of the drainage water accumulated in the bowl 11, an estimation reference for estimating the water level of the drainage water from the detection information or the generation information based on the correlation may be held in the estimation reference holding unit 122. The estimation reference may be an algorithm that receives the detection information or the generation information and outputs the water level of the drainage water. This algorithm is also realized by the neural network or the like, and may be trained by the machine learning. In a case where the above-described floating height detector is provided in the urinal 1, the water level of the drainage may be estimated based on the information detected by the floating height detector.

The control device 110 includes a detection information receiver 111, a discharge state estimator 112, a water level estimator 113, an estimation result output unit 114, and an estimation reference setting unit 115. These configurations are realized by a CPU, a memory, another LSI, or the like of an arbitrary computer in terms of hardware, and are realized by a program loaded in a memory or the like in terms of software, but here, functional blocks realized by cooperation of the hardware and the software are illustrated. Therefore, it is understood by those skilled in the art that these functional blocks can be realized in various forms by only hardware, or a combination of the hardware and the software.

The detection information receiver 111 receives the detection information from detection device 30, and causes the received detection information to be stored in the detection information holding unit 121. In a case where the estimation reference held in the estimation reference holding unit 122 uses the generation information generated from the detection information received from the detection device 30, the detection information receiver 111 generates the generation information from the detection information received from detection device 30, and causes the generation information to be stored in the detection information holding unit 121.

The discharge state estimator 112 estimates the discharge state of the drainage water in the urinal 1 based on the detection information or generation information held in the detection information holding unit 121 by using the estimation reference held in the estimation reference holding unit 122. The discharge state estimator 112 estimates whether or not the discharge port 11C or the discharge path of the urinal 1 is clogged or the degree of clogging.

In addition to the information received from the detection device 30, the discharge state estimator 112 may estimate the discharge state of the drainage water in the urinal 1 based on information receivable from other devices. For example, in a case where the discharge state of the drainage water is estimated based on the time at which the drainage water is continuously detected, the discharge state estimator 112 may further acquire information such as the time at which the user is detected by the human body detection sensor of the urinal 1 and the time at which the washing water is discharged from the water discharge unit 12 to estimate the discharge state of the drainage water. Thus, the discharge state of the drainage water can be estimated more accurately.

The water level estimator 113 estimates the water level of the drainage water accumulated in the bowl 11 of the urinal 1 based on the detection information or generation information held in the detection information holding unit 121 by using the estimation reference held in the estimation reference holding unit 122.

The estimation result output unit 114 outputs the results estimated by the discharge state estimator 112 and the water level estimator 113. For example, the estimation result output unit 114 may display the estimation result on the display device 102, may output the estimation result as a sound from a speaker (not illustrated), or may transmit the estimation result to an external device via the communication device 101. The estimation result output unit 114 may determine an output destination in accordance with the content of the estimation result. For example, in a case where the time at which the drainage water is continuously detected by the detection device 30 becomes longer than a first threshold value, and there is a sign before the discharge port 11C or the discharge path is completely clogged, the estimation result may be transmitted to a management entity or a maintenance entity such as a facility in which the urinal 1 is installed. In a case where the discharge port 11C or the discharge path is clogged and the time at which the drainage water is continuously detected by the detection device 30 is longer than a second threshold value greater than the first threshold value, the estimation result may be transmitted to a cleaning company in charge of cleaning the urinal 1 in addition to the management entity or the maintenance entity. Furthermore, in a case where it is estimated that the water level of the drainage water accumulated in the bowl 11 reaches a certain water level at which there is a possibility of overflowing, or in a case where it is estimated that the drainage water has already overflowed, the estimation result may be transmitted to the cleaning company in addition to the management entity or the maintenance entity. Thus, it is possible to cause an appropriate entity to take appropriate measures according to the discharge state of the drainage water in the urinal 1.

The estimation reference setting unit 115 generates or acquires the estimation reference used by the discharge state estimator 112 and the water level estimator 113, and causes the estimation reference to be stored in the estimation reference holding unit 122. The estimation reference setting unit 115 may acquire the estimation reference from the external device via the communication device 101. Furthermore, the estimation reference may be received from the administrator via the input device 103. The threshold value of the time at which the drainage water is continuously detected, which is to be estimated that the discharge port 11C or the discharge path is clogged, may vary depending on the amount of the washing water discharged in the urinal 1, the discharge time, the attribute of a person who uses the urinal 1, the type of facility in which the urinal 1 is installed, the discharge performance of the discharge port 11C and discharge path of the urinal 1, the volume of the bowl 11 of the urinal 1. Therefore, the estimation reference may be set by the external device or the input device 103 via the estimation reference setting unit 115. Furthermore, the estimation reference may be changed in accordance with a change in the use situation of the urinal 1. In a case where the algorithm of the estimation reference is trained by an external training device, the trained estimation reference may be acquired from the training device.

The estimation reference setting unit 115 may be trained for the estimation reference in a machine learning manner by using the detection information held in the detection information holding unit 121 as training data, and update the estimation reference. The estimation reference setting unit 115 may change the estimation reference based on the history of the detection information held in the detection information holding unit 121.

A part or all of the configurations of the estimation device 100 may be provided in the detection device 30. In this case, these configurations may be provided on the substrate 51 of the detection device 30 or may be realized by the processing device 52.

In some embodiments, an example in which the detection device 30 is installed in the drain trap 13 placed on the discharge port 11C of the urinal 1 and the discharge state of the drainage water from the discharge port 11C is estimated has been described, but the technique of some embodiments can be used to estimate the discharge state of the drainage water from the discharge port of any of a toilet bowl, a washstand, a bathroom, a bathtub, or a sink of a kitchen. Furthermore, the technique of some embodiments can also be used to estimate the discharge state of a liquid from any discharge port for discharging a liquid.

As described above, in some embodiments of the management system, by analyzing the current value or resistance value between the electrodes 54, which is measured by the ammeter, the number of times, amount, and time of the urination, and a component of the urine can be estimated. A management system according to some embodiments manages cleaning of the urinal 1 based on information such as the number of times, amount, and time of the urination, and a component of the urine, which is estimated by analyzing the current value or the resistance value of the drainage water, which is detected by the detection device 30.

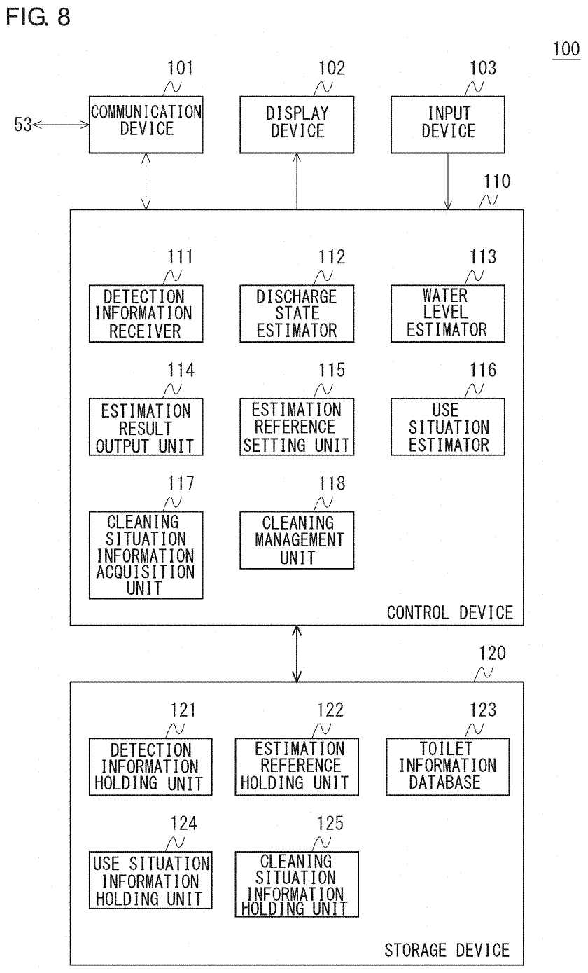

FIG. 8 is a diagram illustrating a configuration of an estimation device according to some embodiments. An estimation device 100 according to some embodiments includes, in addition to the configuration of the estimation device 100 according to FIG. 7, a use situation estimator 116, a cleaning situation information acquisition unit 117, a cleaning management unit 118, a toilet information database 123, a use situation information holding unit 124, and a cleaning situation information holding unit 125. Other configurations and operations are similar to those of embodiments described above. Differences from the embodiments described above will be mainly described.

The toilet information database 123 stores information regarding a toilet room or a facility in which the urinal 1 is installed. The toilet information database 123 stores, for example, information regarding the number of toilet rooms installed in the facility, a position of the toilet room installed in the facility, a floor having the toilet room installed in the facility, the number of urinals installed in the toilet room, a position of the urinal installed in the toilet room, a state of the urinal installed in the toilet room, the model type of urinal installed in the toilet room, a manufacturing number of the urinal installed in the toilet room, a manufacturing date of the urinal installed in the toilet room, a state of the urinal installed in the toilet room, a plan view of the toilet room, the type of device or equipment installed inside or outside the toilet room, the number of devices or equipment installed inside or outside the toilet room, a position of a device or equipment installed inside or outside the toilet room, and a state of the device or equipment installed inside or outside the toilet room.

The use situation information holding unit 124 stores information regarding the use situation of the urinal 1. The use situation information holding unit 124 stores, for each urinal 1, information regarding the number of times, amount, and time of the urination in the urinal 1, and a component of the urine in the urinal 1.

The cleaning situation information holding unit 125 holds information regarding a cleaning situation of the urinal 1 cleaned by a cleaner. The cleaning situation information holding unit 125 stores, for each urinal 1, information regarding a date and time when the cleaner cleaned the urinal 1, a cleaning time, a cleaning content, and a state of the urinal 1 before and after the cleaning.

The use situation estimator 116 estimates the use situation of the urinal 1 based on the detection information or generation information held in the detection information holding unit 121, and causes the estimated use situation to be stored in the use situation information holding unit 124. The use situation estimator 116 estimates the number of times, amount, and time of the urination in the urinal 1, and a component of the urine based on the current value or resistance value measured by the ammeter of the detection device 30. Although the number of times of use of the urinal 1 can be counted using the human body detection sensor or the like, there may be a case where a person who has just passed in front of the urinal 1 is detected and counted, and thus the counted number of times does not necessarily coincide with the number of times of the urination. According to the technique of some embodiments, the use situation of the urinal 1 can be estimated more accurately. The use situation estimator 116 may estimate the use situation of the urinal 1 further based on information acquired from other devices, equipment, or the like installed in the toilet room.

The cleaning situation information acquisition unit 117 acquires information indicating a cleaning situation of the urinal 1 cleaned by the cleaner, and causes the information to be stored in the cleaning situation information holding unit 125. The cleaning situation information acquisition unit 117 acquires, from the cleaner, information regarding a date and time when the cleaner cleaned the urinal 1, a cleaning time, a cleaning content, and a state of the urinal 1 before and after the cleaning.

The cleaning management unit 118 manages cleaning of the urinal 1 based on information indicating the use situation of the urinal 1, which is held in the use situation information holding unit 124 and information indicating a cleaning situation of the urinal 1, which is held in the cleaning situation information holding unit 125. The cleaning management unit 118 determines the number of times, the content, the date and time, the order of cleaning of the urinal 1, and performs an instruction to the cleaner. The cleaning management unit 118 may increase the number of times of the cleaning of the urinal 1 having the greater number of times of the urination, the greater amount of the urination, and the longer urination time, and may change the content of cleaning. Furthermore, in a case where the resistance value detected at the time of urination is small, it is estimated that the amount of salt contained in the urine is great. Therefore, the number of times of cleaning of the urinal 1 may be increased in order to suppress adhesion of a urolith and clogging of the discharge port 11C or the discharge path.

In a case where the discharge state estimator 112 estimates that the discharge state of the discharge port 11C or the discharge path is defective, the cleaning management unit 118 may instruct the cleaner to clean the discharge port 11C or the discharge path of the urinal 1. Furthermore, in a case where the water level estimator 113 estimates that the water level of the drainage water is equal to or higher than a predetermined value, the cleaning management unit 118 may instruct the cleaner to further clean the bowl 11 of the urinal 1 and the surrounding floor.

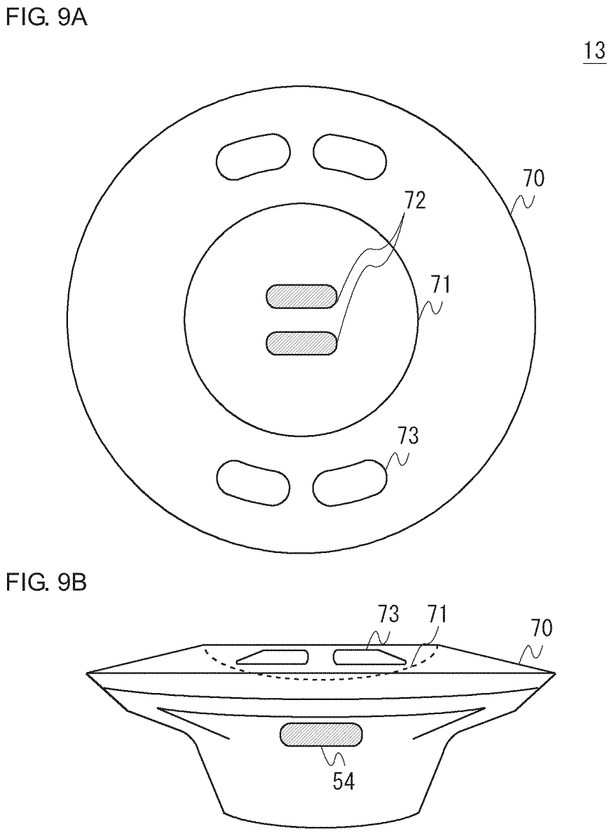

FIGS. 9A-9B are views illustrating another drain trap according to some embodiments. In the example illustrated in the drawings, the detection device is built in the drain trap 13. FIG. 9A is a top view of the drain trap 13, and FIG. 9B is a side view of the drain trap 13. A circular recess 71 is formed near the center of the upper surface of the drain trap 13, and electrodes 72 are provided at the bottom near the center of the recess 71. A circumferential edge portion 70 of the upper surface of the drain trap 13 is inclined so as to be lowered toward the end portion, and an opening 73 is provided on the inclined surface. A lower portion of the drain trap 13 has a shape fitted to the discharge port 11C, and an electrode 54 is provided on a side surface below the opening 73.

Since the electrodes 72 are provided on the upper surface of the drain trap 13 and a part of urine is accumulated in the recess 71 when the user performs urination, the electrodes 72 can detect the urination more reliably. Therefore, the drain trap 13 illustrated in the drawing can be particularly suitably used in the management system of some embodiments. An opening for causing the drainage water accumulated in the recess 71 to fall to the discharge port 11C may be provided in the recess 71, after the washing water is caused to flow after the urination.

In a case where the drainage water remains in the bowl 11, the drainage water falling from the opening 73 on the circumferential edge portion 70 of the drain trap 13 toward the discharge port 11C can be more reliably detected by the electrode 54. Therefore, the drain trap 13 illustrated in the drawing can be suitably used in the management system of embodiments described above.

The processing device 52 and the communication device 53 are provided inside the drain trap 13. The drain trap 13 in the drawing is also configured to float on the water. Thus, the communication intensity of the communication device 53 can be secured, and the stability of wireless communication can be improved. Furthermore, the power required for communication can be reduced, and thus the battery can last longer.

According to the technique of some embodiments, it is possible to perform appropriate cleaning in accordance with the use situation of the urinal 1, and thus, it is possible to improve the cleaning efficiency while keeping the urinal 1 clean.

Although the present disclosure has been described above based on several embodiments, the embodiments merely illustrate the principle and application of the present disclosure. Furthermore, many modification examples and changes in an arrangement are possible in the embodiments without departing from the spirit of the present disclosure specified in the claims.

The present disclosure is applicable to a management system that manages a liquid discharge state in a toilet bowl or the like.

1. A management system comprising:
a detection device comprising:
a main body having a shape installable to a discharge port;
a detector, the detector being provided in the main body, configured to detect a liquid and;
a transmitter configured to transmit information regarding a detection result obtained by the detector; and
an estimation device being configured to receive the information transmitted from the transmitter, and estimate a discharge state of the liquid from the discharge port based on the information received by the receiver.

2. A detection device comprising:
a main body having a shape installable to a discharge port;
a detector, the detector being provided in the main body, configured to detect a liquid; and
a transmitter configured to transmit information regarding a detection result obtained by the detector.

3. The detection device of claim 2, wherein the transmitter transmits the detection result obtained by the detector or a time at which the liquid is continuously detected by the detector.

4. The detection device of claim 2, wherein at least the transmitter is structured to float on the liquid.

5. The detection device of claim 2, wherein the main body is structured to be installed above a drain trap, the drain trap being installed to the discharge port.

6. The detection device of claim 2, further comprising an inclined surface, the inclined surface causing the liquid to flow toward the detector, the detector existing on an upper side to flow toward the detector.

7. The detection device of claim 2, wherein the detector includes at least a pair of electrodes and an ammeter configured to detect a current flowing between the at least a pair of electrodes.

8. The detection device of claim 2, further comprising an estimator configured to estimate a discharge state of the liquid from the discharge port based on the detection result obtained by the detector, wherein the transmitter transmits an estimation result obtained by the estimator.

9. The detection device of claim 8, wherein the estimator estimates clogging of the discharge port or a discharge path connected to the discharge port based on the detection result obtained by the detector.

10. The detection device of claim 9, wherein the estimator estimates that the discharge port or the discharge path connected to the discharge port is clogged in a case where a time at which a liquid is continuously detected by the detector exceeds a predetermined threshold value.

11. The detection device of claim 9, wherein the estimator estimates a degree of clogging of the discharge port or the discharge path connected to the discharge port based on a time at which a liquid is continuously detected by the detector.

12. An estimation device comprising:
a controller configured to:
receive information transmitted from a detection device, the detection device being installed to a discharge port and configured to detect a liquid; and
estimate a discharge state of the liquid from the discharge port based on the information received by the receiver.

13. The estimation device of claim 12, wherein the controller estimates clogging of the discharge port or a discharge path connected to the discharge port based on the information received by the receiver.

14. The estimation device of claim 13, wherein the controller estimates that the discharge port or the discharge path connected to the discharge port is clogged in a case where a time at which a liquid is continuously detected by the detection device exceeds a predetermined threshold value.

15. The estimation device of claim 13, wherein the controller estimates a degree of clogging of the discharge port or the discharge path connected to the discharge port based on a time at which a liquid is continuously detected by the detection device.

16. A drain trap configured to be installed in a discharge port, the drain trap comprising:
a main body having a shape installable to the discharge port;
a detector, the detector being provided in the main body, the detector configured to detect a liquid; and
a transmitter configured to transmit information regarding a detection result obtained by the detector.
